(19) United States
(12) Patent Application Publication
(10) Pub. No.: US 2016/0273587 A1
(43) Pub. Date: Sep. 22, 2016

(54) BEARING STEEL

(71) Applicants: John Beswick, Montfoort (NL); Yves Maheo, Anneyron (FR); Mohamed Sherif, Hilversum (NL)

(72) Inventors: John Beswick, Montfoort (NL); Yves Maheo, Anneyron (FR); Mohamed Sherif, Hilversum (NL)

(73) Assignees: Aktiebolaget SKF, Goteborg (SE); SKF Aerospace France S.A.S, Saint-Vallier (FR)

(21) Appl. No.: 15/070,385

(22) Filed: Mar. 15, 2016

(30) Foreign Application Priority Data
Mar. 16, 2015 (EP) 15290073.4

(51) Int. Cl. F16C 33/62; C22C 38/52; C22C 38/48; C22C 38/42; C22C 38/00; C22C 38/46; C22C 38/04; C22C 38/02; C22C 38/06; F16C 33/64; C22C 38/44

(52) U.S. Cl. CPC F16C 33/62; F16C 33/64; C22C 38/52; C22C 38/48; C22C 38/42; C22C 38/44; C22C 38/46; C22C 38/04; C22C 38/02; C22C 38/06; C22C 38/001; F16C 2204/72; C21D 1/06

(57) ABSTRACT

A steel alloy for a bearing is provided. The alloy having a composition including from 0.04 to 0.1 wt. % carbon, from 11.5 to 13 wt. % chromium, from 1.5 to 3.5 wt. % molybdenum, from 0.3 to 0.8 wt. % vanadium, from 0.3 to 1.75 wt. % nickel from 6 to 9 wt. % cobalt, from 0.1 to 0.4 wt. % silicon, from 0.2 to 0.8 wt. % manganese, from 0 to 2 wt. % copper, from 0 to 0.05 wt. % niobium, from 0 to 0.1 wt. % aluminum, from 0 to 250 ppm nitrogen, from 0 to 30 ppm boron, and the balance iron, together with any unavoidable impurities.

### CROSS-REFERENCE TO RELATED APPLICATIONS

This application claims priority to European patent application no. 15290073.4 filed on 16 Mar. 2015, the contents of which are fully incorporated herein by reference.

### TECHNICAL FIELD

The present invention relates generally to the field of metallurgy. More specifically, the present invention relates to a stainless steel alloy which is used in the manufacture of bearings.

### BACKGROUND

Bearings are devices that permit constrained relative motion between two parts. Rolling element bearings comprise inner and outer raceways and a plurality of rolling elements (for example balls and/or rollers) disposed there between. For long-term reliability and performance it is important that the various elements have a high resistance to rolling contact fatigue, wear, corrosion and creep.

Conventional techniques for manufacturing metal components involve hot-rolling or hot-forging to form a bar, rod, tube or ring, followed by a soft forming/machining process to obtain the desired near net shape component. Surface-hardening and through-hardening processes are well known and are used to locally increase the hardness of surfaces of finished or semi-finished components so as to improve, for example, wear resistance and fatigue resistance. A number of surface or case hardening processes are also known for improving rolling contact fatigue resistance.

A typical hardened bearing steel microstructure is composed of a matrix that often is either bainitic or tempered martensitic, and carbides. The carbides may include cementite particles. For example, in the steel system 100Cr6, they may have the stoichiometry M₃C (M=Metal, being mostly Fe). The carbide particles that are found in typical bearing steel hardened microstructures are crucial in bearing applications especially if slip takes place in the bearing contact during acceleration. In the context of fatigue, however, these particles, albeit relatively very hard and strong and small in size at about 1 μm or less, represent internal micro-notches.

Because hardened metal is usually more brittle than softer metal, through-hardening (that is, hardening the metal uniformly throughout the piece) is not always a suitable choice for uses where the metal part is subject to certain kinds of stress. In such circumstances, case-hardening or surface hardening can be used.

Case-hardening or surface hardening is the process of hardening the surface of a metal object whereby a thin layer of harder metal (called the “case”) is formed at the surface of the object. For iron or steel with low carbon content, which has poor hardness once quenched, the case-hardening process (e.g. case-carburising) involves infusing additional carbon into the case. Case-hardening is usually carried out after the part has been formed into its final shape, for example into a bearing component.

In greater detail, case-hardened steel is generally conducted by diffusing carbon (carburisation), nitrogen (nitriding) and/or boron (boriding) into the outer layer of the steel at an elevated temperature. These are therefore thermochemical processes. They are typically followed by a further heat-treatment of the surface layer to achieve the desired hardness and properties.

With regard to carburising, where carbon is diffused into the surface of low carbon steels to increase the carbon content to sufficient levels so that the surface will produce a hard, wear-resistant layer, there are three types commonly used: gas carburising, liquid carburising (or cyaniding) and solid (pack) carburising. All three processes rely on the transformation of austenite into martensite on quenching. The increase in carbon content at the surface must be high enough to give a martensitic layer with sufficient hardness, typically approximately 750 HV, to provide a wear-resistant surface. The required carbon content at the surface after diffusion is typically 0.8 to 1.2 wt. %. These processes can be carried out on a wide range of plain carbon steels, alloy steels and cast irons where the bulk carbon content is a maximum of 0.4% and usually less than 0.25%.

Stainless steels are known and typically contain a minimum of 10.1% Cr to achieve the desired corrosion resistance. For example, Pyrowear® 675 stainless is a carburising, corrosion-resistant steel designed to provide a case hardness in excess of HRC 60 combined with a tough, ductile core. Pyrowear® 675 stainless has been used in bearing and gearing type applications. Pyrowear® 675 stainless contains approximately 0.07 wt. % C and 13 wt. % Cr as well as Mo, V, Ni, Co, Si and Mn and Fe.

An object of the present invention to address some of the problems associated with the prior art, or at least to provide a commercially useful alternative thereto.

### SUMMARY OF THE INVENTION

The present invention provides a stainless steel alloy for a bearing, the alloy having a composition having:
from 0.04 to 0.1 wt. % carbon,
from 11.5 to 13 wt. % chromium,
from 1.5 to 3.5 wt. % molybdenum,
from 0.3 to 0.8 wt. % vanadium,
from 0.3 to 1.75 wt. % nickel,
from 6 to 9 wt. % cobalt,
from 0.1 to 0.4 wt. % silicon,
from 0.2 to 0.8 wt. % manganese,
from 0 to 2 wt. % copper,
from 0 to 0.05 wt. % niobium,
from 0 to 0.1 wt. % aluminium,
from 0 to 250 ppm nitrogen,
from 0 to 30 ppm boron, and
the balance iron, together with any unavoidable impurities.

In the present invention, the steel alloy composition provides from 0.04 to 0.1 wt. % C, preferably from 0.05 to 0.09 wt. % C, more preferably from 0.06 to 0.08 wt. % C, still more preferably approximately 0.07 wt. % C. In combination with the other alloying elements, this results in the desired microstructure (e.g. as-quenched martensite matrix) and mechanical properties conducive to bearing applications. The steel alloy is preferably case-carburisable. While a C content higher than about 0.1 wt. % may improve the strength, it is undesirable in that it depresses the martensite start temperature (Ms) of the core austenite upon quenching during hardening. The high martensite start temperature of the core, relative to that of the case, ensures obtaining a good compressive residual stress profile within the bearing component. For this reason the C content is chosen to be ≦0.1 wt. %, preferably ≦0.09 wt. %, more preferably ≦0.08 wt. %.

The steel composition provides from 11.5 to 13 wt. % Cr, preferably from 11.7 to 12.7 wt. % Cr, more preferably from 11.7 to 12.5 wt. % Cr, still more preferably from 12 to 12.5 wt. % Cr. Cr is known to be beneficial in terms of corrosion resistance and a stainless steel must contain a minimum amount of Cr. Therefore, the minimum Cr content is set at 11.5 wt. %. The Cr content (in conjunction with the other alloying elements, particularly the Mo) is preferably chosen to minimise the occurrence of an undesirable high temperature ferrite phase (δ-ferrite) in the core, while maximising the PREN number (see below). Cr is a ferrite stabiliser and, therefore, the content thereof is preferably such that the undesirable δ-ferrite phase in the core is not formed during heat treatment. The δ-ferrite phase, if present in the core, may cause an appreciable increase in the austenite carbon content, which in turn lowers the martensite start temperature. In addition, poor mechanical properties are expected when δ-ferrite is present in the core in significant quantities. For these reasons, the Cr content is chosen to be ≦13 wt. %, preferably ≦12.7 wt. %, more preferably ≦12.5 wt. %.

The steel composition comprises from 1.5 to 3.5 wt. % Mo. Mo may act to avoid austenite grain boundary embrittlement owing to impurities such as, for example, phosphorus. Mo may also act to increase hardenability. Mo has a greater effect than Cr on the PREN number. Accordingly, for a given Cr eq. number, the Mo and Cr contents are preferably balanced to minimise the occurrence of δ-ferrite in the core while, maximising the PREN number. Mo is a ferrite stabiliser and, therefore, the content thereof is preferably such that the δ-ferrite phase in the core is not formed during heat treatment. The δ-ferrite phase, if present in the core, may cause an appreciable increase in the austenite carbon content, which in turn lowers the martensite start temperature. In addition, poor mechanical properties are expected when δ-ferrite is present in the core in significant quantities. For these reasons, the Mo content is chosen to be 1.5 to 3.5 wt. %, preferably 1.8 to 3.2 wt. %, more preferably from 2 to 3 wt. %.

As noted above, Mo and Cr affect the pitting resistance equivalent number (PREN), which is defined as PREN=Cr %+3.3 Mo % (elements in wt. %). PREN is a well-known indication of the corrosion resistance of stainless steel in a chloride-containing environment. In general: the higher the PREN value, the more corrosion resistant the steel. In the present invention, the steel alloy composition may preferably have a PREN (core) of 18 to 22, preferably 18.5 to 22, more preferably 19 to 22 wt. %. The upper limit is preferably ≧20, more preferably ≧21, still more preferably ≧21.5, and most preferably about 22.

The steel composition provides from 0.3 to 0.8 wt. % V. The addition of V has been found to be beneficial in terms of improved hot-hardness and also control of the structure's response during tempering. In addition, V is beneficial in ensuring a fine-grained structure. Too high a V content will lock more carbon in MC-type of carbides, which leads to the as-quenched martensite matrix not exhibiting enough strength and hardness, which are necessary for bearing applications. In addition, V is a ferrite stabilizer, so its content must be balanced with other austenite-stabilising elements. Therefore, in the present invention, the V content is 0.3 to 0.8 wt. %, preferably 0.4 to 0.7 wt. %, more preferably 0.5 to 0.6 wt. %.

The steel composition provides from 0.3 to 1.75 wt. % Ni. The Ni content is reduced in the present invention such that the Co content can be raised (see below). The low carbon content of the core ensures good toughness and the Ni content may be reduced accordingly. Ni is also a relatively expensive alloying element. Therefore, in the present invention, the Ni content is 0.3 to 1.75 wt. %, preferably 0.3 to 1.5 wt. %, more preferably 0.4 to 1.2 wt. %, still more preferably 0.5 to 1 wt. %.

The steel composition provides from 6 to 9 wt. % Co. Co and Ni both contribute to the Ni eq. and, as such, are preferably balanced. For a given N eq., the lower Ni content enables raising the Co content of the alloy. A higher Co content has been found beneficial in terms of the formation of finer carbides in the structure with benefits in terms of higher hardness and strength. However, too high a Co content may depress the Ms temperature, resulting in difficulties in transforming austenite into martensite on quenching. Therefore, in the present invention, the Co content is 6 to 9 wt. %, preferably 6 to 8 wt. %, more preferably 6.5 to 7.7 wt. %, still more preferably 7 to 7.5 wt. %.

The steel alloy composition provides from 0.1 to 0.4 wt. % Si, preferably from 0.1 to 0.3 wt. % Si, more preferably from 0.15 to 0.25 wt. % Si. In combination with the other alloying elements, this results in the desired microstructure with a minimum amount of retained austenite. Si improves the tempering resistance of the steel microstructure and for this reason a minimum amount of 0.15 wt. % Si is added. Si may also contribute to the Cr eq, therefore, too high a Si content may result in more likelihood of stabilising the undesirable δ-ferrite phase in the core of the component. In addition, Si may lower the elastic properties of the matrix. For these reasons, the maximum silicon content is 0.4 wt. %, preferably 0.3 wt. %, more preferably 0.25 wt. %.

The steel alloy composition provides from 0.2 to 0.8 wt. % Mn, preferably 0.3 to 0.7 wt. % Mn, more preferably 0.4 to 0.6 wt. % Mn. The Mn content is at least 0.2 wt. %, since this, in combination with the other alloying elements, helps to achieve the desired microstructure and properties. Mn also acts to improve hardenability. In addition, Mn acts to increase the stability of austenite relative to ferrite. However, Mn levels above about 0.8 wt. % may serve to increase the amount of retained austenite. This may lead to practical metallurgical issues such as stabilising the retained austenite too much, leading to potential problems with the dimensional stability of the bearing components.

The steel alloy composition may be further defined by the Ni_{eq} and Cr_{eq}. In particular, the Ni_{eq} is defined as Ni+Co+0.5Mn+30C and may typically range from 10 to 11, preferably 10.1 to 10.8, more preferably 10.2 to 10.6, still more preferably 10.3 to 10.5. Similarly, the Cr_{eq} is defined as Cr+2Si+1.5Mo+5V and may typically range from 17.8 to 20, preferably 18 to 19.7, more preferably 18.2 to 19.6, still more preferably 18.5 to 19.4.

As noted above, the steel composition may optionally include one or more of the following elements:
from 0 to 2 wt. % copper,
from 0 to 0.05 wt. % niobium,
from 0 to 0.1 wt. % aluminium,
from 0 to 250 ppm nitrogen, and
from 0 to 30 ppm boron.

The steel composition may optionally include up to 2 wt. % Cu, for example from 0.01 to 0.5 wt. % Cu. Cu increases the alloy hardenability and corrosion resistance. However, its amount must be properly controlled as it is an austenite stabiliser. If present in levels in excess of 0.3 wt. %, the Cu content is tied to that of Ni given that the wt. % ratio of Cu/Ni is preferably approximately 2 (plus or minus 0.2). This ensures that hot-shortness is mitigated.

The steel composition may optionally include up to 0.05 wt. % Nb. In particular, to avoid excessive austenite grain growth during case-carburising or heat treatment, small amounts of Nb (preferably 0.005 to 0.02 wt. %) may be added.

The steel composition may optionally include up to 0.1 wt. % Al, for example from 0.005 to 0.05 wt. % Al, preferably from 0.01 to 0.03 wt. % Al. Al may serve as a deoxidizer. However, the use of Al requires stringent steel production controls to ensure cleanliness and this increases the processing costs. Therefore, the steel alloy provides no more than 0.05 wt. % Al. However, the Al content will have to be reduced to a trace level and preferably kept to an absolute minimum if the alloy is manufactured by a powder metallurgical route or by spray-forming.

In some embodiments, nitrogen may be added such that the steel alloy provides from 50 to 250 ppm N, preferably from 75 to 150 ppm N. The presence of N may be beneficial for promoting the formation of complex nitrides and/or carbonitrides. In other embodiments, there is no deliberate addition of N. Nevertheless, the alloy may necessarily still comprise at up to 50 ppm N.

If the alloy is manufactured by a VIM-VAR processing route, the Al concentration may be in the range 0.01 to 0.03 wt. %, for example, and the N concentration may be in the range of 30 to 60 ppm. Both elements help in pinning austenite grain boundaries in the form of aluminium nitride precipitates, thus ensuring a finer-grained structure that is beneficial for demanding bearing applications.

The steel composition may optionally include from 0 to 30 ppm B. B may be added, for example, when increased hardenability is desired.

It will be appreciated that the steel alloy referred to herein may contain unavoidable impurities, although, in total, these are unlikely to exceed 0.3 wt. % of the composition. Preferably, the alloys contain unavoidable impurities in an amount of not more than 0.1 wt. % of the composition, more preferably not more than 0.05 wt. % of the composition. In particular, the steel composition may also include one or more impurity elements. A non-exhaustive list of impurities includes, for example:

from 0 to 0.025 wt. % phosphorous
from 0 to 0.015 wt. % sulphur
from 0 to 0.04 wt. % arsenic
from 0 to 0.075 wt. % tin
from 0 to 0.075 wt. % antimony
from 0 to 0.01 wt. % tungsten
from 0 to 0.005 wt. % titanium
from 0 to 0.002 wt. % lead

The steel alloy composition preferably provides little or no S, for example from 0 to 0.015 wt. % S.

The steel alloy composition preferably provides little or no P, for example from 0 to 0.025 wt. % P.

The steel composition preferably provides ≦15 ppm O. O may be present as an impurity. The steel composition preferably provides ≦30 ppm Ti. Ti may be present as an impurity. The steel composition preferably provides ≦50 ppm Ca. Calcium may be present as an impurity.

In a preferred embodiment of the present invention, the steel alloy composition provides:
from 0.06 to 0.08 wt. % carbon,
from 11.7 to 12.5 wt. % chromium,
from 1.8 to 3.2 wt. % molybdenum,
from 0.4 to 0.7 wt. % vanadium,
from 0.4 to 1.2 wt. % nickel
from 6.5 to 7.7 wt. % cobalt,
from 0.1 to 0.3 wt. % silicon,
from 0.3 to 0.7 wt. % manganese,
from 0 to 0.4 wt. % copper,
from 0 to 0.05 wt. % niobium,
from 0 to 0.05 wt. % aluminium,
from 0 to 150 ppm nitrogen, and
the balance iron, together with any unavoidable impurities.

The steel alloy compositions according to the present invention may consist essentially of the recited elements. It will therefore be appreciated that in addition to those elements that are mandatory other non-specified elements may be present in the composition provided that the essential characteristics of the composition are not materially affected by their presence.

The steel alloy compositions according to the present invention preferably have a microstructure having martensite (typically tempered martensite), (ii) carbides, and/or carbonitrides, and (iii) optionally some retained austenite. A low level of retained austenite is advantageous in that it improves dimensional stability of a bearing component. The microstructure may further comprise nitrides. Also, it is preferable that there is little or none of the undesirable δ-ferrite phase in the microstructure. A level of ≦10%, preferably ≦3% is preferred.

The structure of the steel alloys may be determined by conventional microstructural characterisation techniques such as, for example, optical microscopy, TEM, SEM, AP-FIM, and X-ray diffraction, including combinations of two or more of these techniques.

The steel alloy may exhibit high hardness, corrosion resistance and/or dimensional stability. This means that the steel alloy can usefully find application in the manufacture of, for example, a bearing component such as, for example, a rolling element and an inner or outer raceway. Thus, according to another aspect of the present invention, there is provided a bearing component, having a steel alloy as herein described. Examples of bearing components, where the stainless steel can be used, include a rolling element (e.g. ball, cylinder or tapered rolling element), an inner ring, and an outer ring. The present invention also provides a bearing having a bearing component as herein described.

The steel alloy or bearing component may be subjected to surface modifications whether thermo-chemical, mechanical, or both. Such processes may be applied to increase the performance of the bearing component.

The present invention will now be described further with reference to a suitable heat treatment for the steel alloy, provided by way of example.

### BRIEF DESCRIPTION OF THE FIGURES

The invention will now be described further, by way of example, with reference to the accompanying non-limiting drawings, in which:

FIG. 1 is a phase diagram of an example of a steel alloy according to the present invention.

FIG. 2 is a micrograph of the microstructure of a steel alloy according to the present invention (scale indicated).

### DETAILED DESCRIPTION OF THE INVENTION

The present invention will now be described further. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

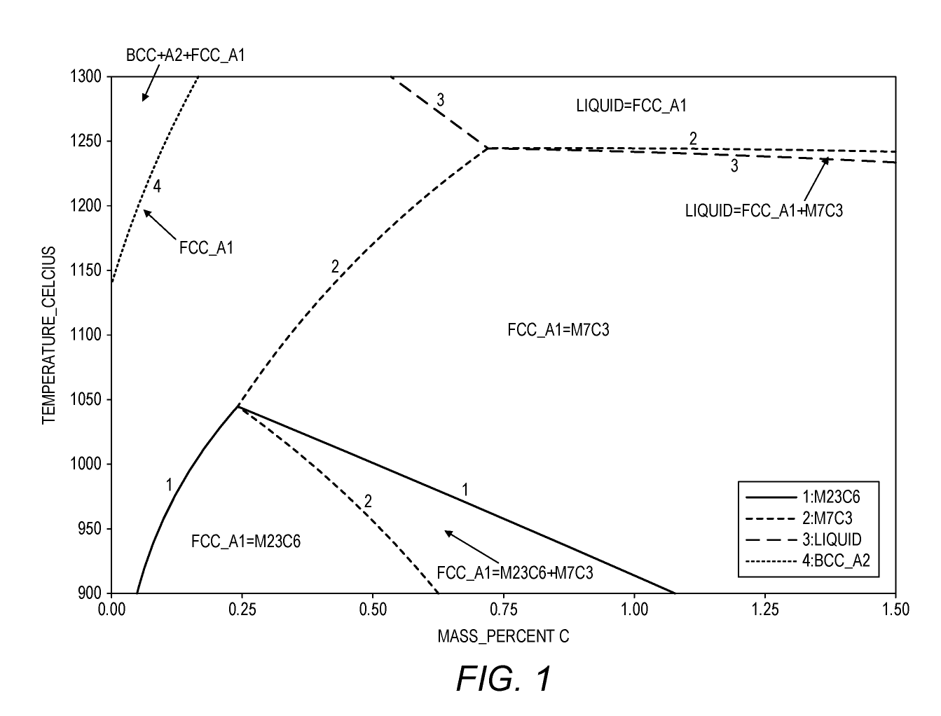

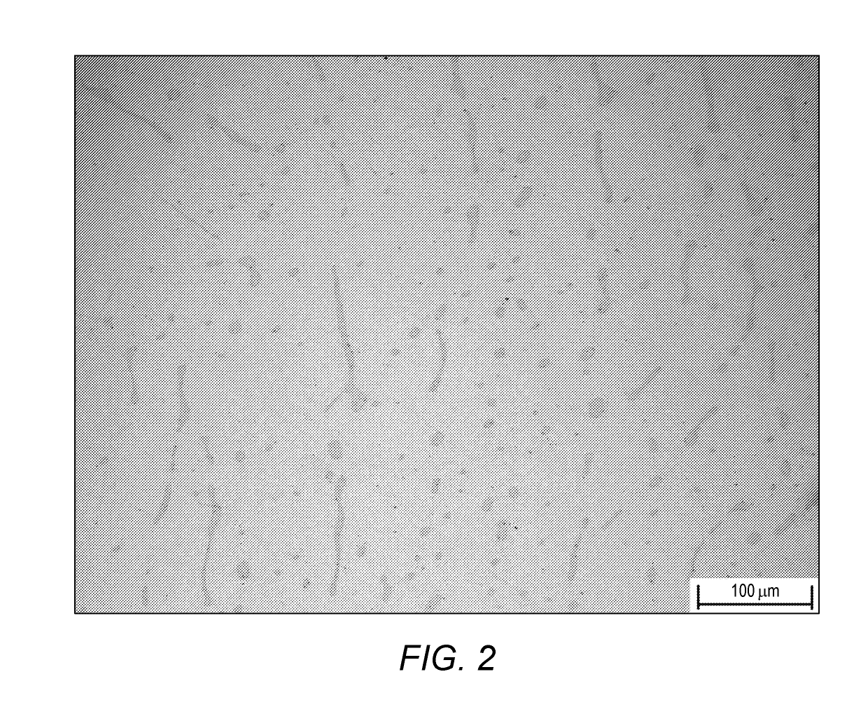

As can be seen in FIG. 1, in the steel alloy according to the present invention, the formation of the δ-ferrite phase is avoided during soaking at 1200° C. See also Examples 1, 2 and 3 below, and FIG. 2, which shows “traces” (i.e. very small amounts) of delta-ferrite (dark grey) after short homogenisation time at 1100° C. The predominant phase is martensite.

The stainless steel may be produced by, for example, a double vacuum melting VIM-VAR process, by a powder metallurgy (PM) process route, or by spray-forming. In addition, the core alloy, by virtue of being low in carbon, may also be 3D printed. These are also conventional manufacturing techniques. The Al content is reduced to trace level and preferably kept to a minimum in the PM or the spray-formed alloy variant. For the VIM-VAR variant, the Al concentration can be in the range of 0.01 to 0.03 wt. %. The N concentration can be in the range of 30 to 60 ppm. Both elements help in pinning austenite grain boundaries in the form of aluminium nitride precipitates, thus ensuring a finer-grained structure that is beneficial for demanding bearing applications.

As noted above, to avoid excessive austenite grain growth during case-carburising or heat treatment, small amounts of Nb of about 0.02 wt. % may be added.

The forging process of the steel articles is controlled such that the grain sizes are sufficiently fine for the subsequent carburising process not to result in the formation of excessively large grain boundary carbides. For example, the grain sizes may typically range from 30 to 65 μm.

The stainless steel according to the present invention is designed for case-carburising, preferably at reduced pressure (less than the atmospheric pressure), and usually after a suitable preoxidation step (e.g. heating clean bearing components in air at 875 to 1050° C. for 1 hour, followed by air cooling). For example, carburising may be conducted at a temperature in the range of 870 to 950° C. in a carbon-containing medium. Such carburising treatments are conventional in the art and ensure sufficient carbon-enrichment in the carburised case such that there is adequate ΔMs (of the austenite) between the core and the case. This, in turn, ensures the development of a beneficial compressive residual stress profile through the thickness of the bearing component's hardened case and towards the core.

After case-carburising, the bearing components are typically hardened and tempered. After the first temper, the parts may be deep-frozen at near liquid nitrogen temperature then re-tempered. Again, such treatments are conventional in the art.

Hardening consists of austenitisation at, for example, about 1100° C., followed by an oil or gas quench. Tempering can be double or, if necessary, even triple-tempering, with sub-zero treatments in-between the temper steps.

For exceptional resistance to rolling contact fatigue, the case-carburised, hardened and tempered bearing components may be followed by surface nitriding or boriding, for example, to further increase the surface hardness of the bearing components. This is particularly applicable to the surface hardness of bearing raceways. Thus, in a preferred embodiment, once a surface of the bearing component has been case-carburised, the surface may be subjected to a surface nitriding treatment to further improve the mechanical properties of the surface layer.

The steel alloy or bearing component may be subjected to a surface finishing technique. For example, burnishing, especially for raceways, followed by tempering and air-cooling. Afterwards, the steel alloy or bearing component may be finished by means of hard-turning and/or finishing operations such as, for example, grinding, lapping and honing.

The burnishing and tempering operations may cause the yield strength of the affected areas to increase with significant improvement in hardness, compressive residual stress and better resistance to rolling contact fatigue.

### Examples

The present invention will now be described further with reference to the following non-limiting examples—see Table 1.

TABLE 1
The chemical composition of three stainless steels, Example 1,
Example 2 and Example 3*, in wt. %. The balance is iron together with any
unavoidable impurities.

| | | | | | | | | | Cr | Ni | PREN |
|---|---|---|---|---|---|---|---|---|---|---|---|
| Element | C | Cr | Mo | V | Ni | Co | Si | Mn | eq. | eq. | (core) |
| Example 1 | 0.07 | 12.5 | 2.0 | 0.6 | 0.5 | 7.5 | 0.15 | 0.50 | 18.8 | 10.4 | 19.1 |
| Example 2 | 0.07 | 12.0 | 2.75 | 0.5 | 1.0 | 7.0 | 0.15 | 0.50 | 18.9 | 10.4 | 21.1 |
| Example 3 | 0.08 | 12.1 | 2.5 | 0.5 | 1.0 | 7.2 | 0.16 | 0.47 | 18.7 | 10.8 | 20.4 |

*In Example 3, the alloy further contains 0.026 wt. % Al, 0.03 wt. % Nb, 0.02 wt. % N and <0.005 wt. % Cu.

These steel alloys may be manufactured as described above and formed into bearing components by conventional techniques. As can be seen in FIG. 1, the formation of the δ-ferrite phase is avoided during soaking at 1200° C. during homogenization.

The alloys lend themselves to case-carburising, preferably at reduced pressure (less than the atmospheric pressure). For example, carburising may be conducted at a temperature of 900° C. in a carbon-containing medium. As noted above, such carburising treatments are conventional in the art and ensure sufficient carbon-enrichment in the carburised case such that there is adequate ΔMs (of the austenite) between the core and the case. This, in turn, ensures a beneficial compressive residual stress profile through the thickness of the bearing component's hardened case and towards the core.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A steel alloy for a bearing, the alloy having a composition comprising:
from 0.04 to 0.1 wt. % carbon,
from 11.5 to 13 wt. % chromium,
from 1.5 to 3.5 wt. % molybdenum,
from 0.3 to 0.8 wt. % vanadium,
from 0.3 to 1.75 wt. % nickel
from 6 to 9 wt. % cobalt,
from 0.1 to 0.4 wt. % silicon,
from 0.2 to 0.8 wt. % manganese,
from 0 to 2 wt. % copper,
from 0 to 0.05 wt. % niobium,
from 0 to 0.1 wt. % aluminium,
from 0 to 250 ppm nitrogen,
from 0 to 30 ppm boron, and
the balance iron, together with any unavoidable impurities.

2. The steel alloy of claim 1, further comprising from 0.05 to 0.09 wt. % carbon.

3. The steel alloy of claim 1, further comprising from 11.7 to 12.5 wt. % chromium.

4. The steel alloy of claim 1, further comprising from 1.8 to 3.2 wt. % molybdenum.

5. The steel alloy of claim 1, further comprising from 0.4 to 0.7 wt. % vanadium.

6. The steel alloy of claim 1, further comprising from 0.3 to 1.5 wt. % nickel.

7. The steel alloy of claim 1, further comprising from 6.5 to 7.7 wt. % cobalt.

8. The steel alloy of claim 1, further comprising from 0.1 to 0.3 wt. % silicon.

9. The steel alloy of claim 1, further comprising from 0.3 to 0.7 wt. % manganese.

10. The steel alloy of claim 1, further comprising:
from 0.06 to 0.08 wt. % carbon,
from 11.7 to 12.5 wt. % chromium,
from 1.8 to 3.2 wt. % molybdenum,
from 0.4 to 0.7 wt. % vanadium,
from 0.4 to 1.2 wt. % nickel
from 6.5 to 7.7 wt. % cobalt,
from 0.1 to 0.3 wt. % silicon,
from 0.3 to 0.7 wt. % manganese,
from 0 to 0.4 wt. % copper,
from 0 to 0.05 wt. % niobium,
from 0 to 0.05 wt. % aluminium,
from 0 to 150 ppm nitrogen, and
the balance iron, together with any unavoidable impurities.

11. The steel alloy composition of claim 1, further comprising having a microstructure martensite, one or more of carbides, nitrides and/or carbonitrides, and optionally retained austenite.

12. A bearing component made from a steel alloy according to claim 1.

13. A bearing component as claimed in claim 12, wherein one of a rolling element, a bearing inner ring and a bearing outer ring is provided.

14. A bearing component as claimed in claim 12, wherein a surface of the bearing component is case-carburised.

15. A bearing component as claimed in claim 14, wherein a surface of the bearing component is case-carburised and the surface is subsequently surface nitrided.

16. A bearing comprising:
a bearing component made from a steel alloy, the steel alloy having a composition the provides;
from 0.04 to 0.1 wt. % carbon,
from 11.5 to 13 wt. % chromium,
from 1.5 to 3.5 wt. % molybdenum,
from 0.3 to 0.8 wt. % vanadium,
from 0.3 to 1.75 wt. % nickel
from 6 to 9 wt. % cobalt,
from 0.1 to 0.4 wt. % silicon,
from 0.2 to 0.8 wt. % manganese,
from 0 to 2 wt. % copper,
from 0 to 0.05 wt. % niobium,
from 0 to 0.1 wt. % aluminium,
from 0 to 250 ppm nitrogen,
from 0 to 30 ppm boron, and
the balance iron, together with any unavoidable impurities.

17. The steel alloy of claim 1, further comprising having approximately 0.07 wt. % carbon.

18. The steel alloy of claim 1, further comprising having from 12 to 12.5 wt. % chromium.

19. The steel alloy of claim 1, further comprising having from 2 to 3 wt. % molybdenum.
